(19) United States
(12) Patent Application Publication
(10) Pub. No.: US 2021/0070930 A1
(43) Pub. Date: Mar. 11, 2021

(54) THERMOPLASTIC POLYESTER HAVING IMPROVED RESISTANCE TO THE PHENOMENON OF CRACKING

(71) Applicant: ROQUETTE FRERES, Lestrem (FR)

(72) Inventors: Nicolas JACQUEL, LAMBERSART (FR); Hélène AMEDRO, BETHUNE (FR); René SAINT-LOUP, LOMME (FR)

(21) Appl. No.: 16/971,073

(22) PCT Filed: Feb. 19, 2019
(86) PCT No.: PCT/FR2019/050371

§ 371 Date: Aug. 19, 2020

(30) Foreign Application Priority Data
Feb. 19, 2018 (FR) 18 51391

(51) Int. Cl. C08G 63/672

(52) U.S. Cl. CPC C08G 63/672

(57) ABSTRACT

The invention relates to the field of polymers, particularly a thermoplastic polyester having an improved resistance to the cracking phenomenon, to the production method thereof, and to the use of same for producing plastic items. The thermoplastic polyester comprises at least one 1,4:3,6-dianhydrohexitol motif (A), at least one diol motif (B), other than the 1,4:3,6-dianhydrohexitol motif (A), at least one aromatic dicarboxylic acid motif (C) and at least one branching agent, and has a reduced viscosity in solution of a minimum of 0.75 dL/g and a maximum of 1.5 dL/g. Said thermoplastic polyester is advantageous in that it is particularly resistant to the phenomenon of cracking and also has improved esterification and polycondensation times during the production method thereof.

### FIELD OF THE INVENTION

The present invention relates to the field of polymers and particularly relates to a thermoplastic polyester having improved resistance to the cracking phenomenon, to the process for producing same and also to the use thereof for the production of plastic items.

### TECHNOLOGICAL BACKGROUND OF THE INVENTION

Over time, plastics have become essential and are part of the daily life of millions of people. Plastics are generally a mixture of polymers capable of being molded, shaped, often hot and under pressure, in order to obtain semi-finished or finished items. Due to their nature, plastics can be converted at high rates into all kinds of objects and thus find applications in various and varied fields.

Certain polymers, in particular aromatic polyesters, have thermal properties allowing them to be used directly for the production of materials. This involves for example polyethylene terephthalate (PET). However, for certain applications or under certain conditions of use, the properties of PET, in particular impact resistance or thermal resistance, need to be improved. Consequently glycol-modified PETs (PETgs) have been developed. These are generally polyesters comprising, in addition to the ethylene glycol and terephthalic acid units, cyclohexanedimethanol (CHDM) units. The introduction of this diol into the PET enables it to adapt the properties to the intended application, for example to improve its impact strength or its optical properties.

Other modified PETs have also been developed by introducing, into the polyester, 1,4:3,6-dianhydrohexitol units, in particular isosorbide (PEITs). These modified polyesters have higher glass transition temperatures than the unmodified PETs or the PETgs comprising cyclohexanedimethanol units. In addition, 1,4:3,6-dianhydrohexitols have the advantage of being able to be obtained from renewable resources such as starch.

As mentioned previously, it is sometimes necessary to adapt the properties of polyester so that it is compatible with the constraints imposed by certain processes and by the applications for which they are used.

For example, under environmental constraints such as the action of chemical stress, as caused by sodium hydroxide or terpenes, or the action of physical stress, such as mechanical stress, deformations can manifest themselves by means of shear bands, splits or cracks, also called cracking phenomenon. This phenomenon contributes to an increase in structural irregularities and leads to an acceleration of damage and to a fragile rupture or plastic instability of the polyester. Thus, increasing the resistance of polyesters to this cracking phenomenon is therefore of most particular interest.

In this respect, the publication by Sanches et al. “Environmental stress cracking behavior of bottle and fiber grade poly(ethylene terephthalate)”, Polymer Engineering and Science (2008), 48 (10), 1953-1952, describes for example that the resistance to the cracking phenomenon of bottles can be improved by increasing in particular the molar mass and the degree of crystallinity of polyethylene terephthalate.

Document WO 2014/183812 describes a method of producing a PET bottle having improved resistance to the cracking phenomenon under environmental stress. In particular, a method is described in which the amorphous parts of the PET bottle, or the parts having a low degree of crystallinity, are treated by application of an organic solvent or an aqueous solution of an organic solvent. The organic solvent is chosen from acetone, ethyl acetate, pentan-2-one, toluene, 2-propanol, pentane, methanol or mixtures thereof.

This method however has a double disadvantage in terms of cost and time in that it requires the use of an organic solvent and the implementation of an additional step in the process for producing the bottle by means of applying said solvent to said bottle. Thus, the bottle does not intrinsically have the properties of resistance to cracking phenomenon.

The publication by Demirel et al. “Experimental study of preform reheat temperature in two-stage injection stretch blow molding”, Polymer Engineering and Science (2013), 53 (4), 868-873, describes that reducing coupled reheating temperatures and maintaining the temperature profiles of the preforms ensure high resistance to the cracking phenomenon in bottles obtained by two-step injection blow molding. Specific implementation conditions within the processes for producing PET bottles which make it possible to limit the cracking phenomenon have also been investigated in other publications, such as for example the publication by Zagarola et al. “Blow and injection molding process set-ups play a key role in stress crack resistance for PET bottles for carbonated beverages”.

However, although solutions are present, there is still a need to develop alternatives making it possible to limit the cracking phenomenon, in particular in thermoplastic polyesters comprising 1,4:3,6-dianhydrohexitol units for which no solution has been developed to date.

Thus, it is to the credit of the applicant to have been able to develop a new thermoplastic polyester having improved resistance to the cracking phenomenon. This thermoplastic polyester is also particularly advantageous in that it has shorter polymerization and esterification times than the already known thermoplastic polyesters.

### SUMMARY OF THE INVENTION

A first subject of the invention relates to a thermoplastic polyester comprising:
at least one 1,4:3,6-dianhydrohexitol unit (A),
at least one diol unit (B), other than the 1,4:3,6-dianhydrohexitol unit (A),
at least one aromatic dicarboxylic acid unit (C),

said thermoplastic polyester being characterized in that it comprises a branching agent and in that it has a reduced viscosity in solution of at least 0.75 dl/g and at most 1.5 dl/g measured using an Ubbelohde capillary viscometer at 25° C. in an equi-mass mixture of phenol and ortho-dichlorobenzene after dissolution of the polymer at 135° C. with stirring, the concentration of thermoplastic polyester introduced being 5 g/l.

This thermoplastic polyester has the advantage of being particularly resistant to the cracking phenomenon and also has improved esterification and polycondensation times. Indeed, the thermoplastic polyester according to the invention has a shorter polycondensation time than the equivalent thermoplastic polyesters based on 1,4:3,6-dianhydrohexitol containing no branching agent.

A second subject of the invention relates to a process for producing the abovementioned thermoplastic polyester, said process comprising:
a step of introducing, into a reactor, monomers comprising at least one 1,4:3,6-dianhydrohexitol (A), at least one diol (B) other than the 1,4:3,6-dianhydrohexitols (A) and at least one terephthalic acid (C), the ((A)+(B))/(C) molar ratio ranging from 1.05 to 1.5;
a step of introducing, into the reactor, a branching agent;
a step of introducing, into the reactor, a catalytic system;
a step of polymerizing said monomers in the presence of the branching agent so as to form the thermoplastic polyester, said step consisting of:
   a first stage of oligomerization, during which the reaction medium is stirred under an inert atmosphere at a temperature ranging from 230 to 280° C., advantageously from 250 to 260° C., for example 255° C.;
   a second stage of condensation of the oligomers, during which the oligomers formed are stirred under vacuum, at a temperature ranging from 240 to 300° C. so as to form the thermoplastic polyester, advantageously from 260 to 270° C., for example 265° C.;
a step of recovering the thermoplastic polyester having improved resistance to the cracking phenomenon;
optionally, a step of solid-state post-condensation of the recovered thermoplastic polyester.

Finally, another subject of the invention relates to the use of a thermoplastic polyester as defined above, for the production of a semi-finished or finished plastic item. This use is particularly advantageous since, because of the improved properties of the thermoplastic polyester according to the invention, the plastic items obtained have better resistance to the cracking phenomenon.

### DETAILED DESCRIPTION OF THE INVENTION

A first subject of the invention relates to a thermoplastic polyester comprising:
at least one 1,4:3,6-dianhydrohexitol unit (A),
at least one diol unit (B), other than the 1,4:3,6-dianhydrohexitol unit (A),
at least one aromatic dicarboxylic acid unit (C),

said thermoplastic polyester being characterized in that it comprises a branching agent and a reduced viscosity in solution of at least 0.75 dl/g and at most 1.5 dl/g measured using an Ubbelohde capillary viscometer at 25° C. in an equi-mass mixture of phenol and ortho-dichlorobenzene after dissolution of the polymer at 135° C. with stirring, the concentration of thermoplastic polyester introduced being 5 g/l.

Surprisingly, the applicant has found that the presence of a branching agent makes it possible to prevent, or at the very least to limit, the cracking phenomena in a thermoplastic polyester comprising a 1,4:3,6-dianhydrohexitol unit. The thermoplastic polyester according to the present invention thus has the particularity of having high resistance to the cracking phenomenon. Without wishing to be bound by any theory, it seems that the use of such a branching agent in the thermoplastic polyester would make it possible to create branches between the various units and to promote the relaxation of the stresses that may be imposed on the thermoplastic polyester. This relaxation has the visible consequence of reducing, or even preventing, the cracking phenomenon.

Also surprisingly, the applicant has found that the presence of a branching agent makes it possible to reduce the esterification and polycondensation times of the thermoplastic polyester, which represents an advantage in terms of production process. To the knowledge of the applicant, this is the first time that the combination of an improved crack resistance and a faster esterification and polycondensation time has been developed and demonstrated within one and the same thermoplastic polyester comprising a 1,4:3,6-dianhydrohexitol unit. Likewise, compared to PET-based polyesters, the thermoplastic polyester according to the invention exhibits improved thermal resistance.

The thermoplastic polyester according to the present invention therefore comprises a branching agent. The branching agent can be chosen from the group comprising malic acid, sorbitol (D-Glucitol), glycerol, pentaerythritol, pyromellitic anhydride (1H,3H-furo[3,4-f] [2]benzofuran-1,3,5,7-tetrone), pyromellitic acid (1,2,4,5-benzenetetracarboxylic acid), trimellitic anhydride, trimesic acid (1,3,5-benzenetricarboxylic acid), citric acid, trimethylolpropane (2-ethyl-2-(hydroxymethyl)propane-1,3-diol), and mixtures thereof. Preferably, the branching agent is pentaerythritol.

The weight amount of branching agent within the thermoplastic polyester according to the invention is from 0.001 to 1% relative to the total weight amount of the thermoplastic polyester. Preferably, the amount of branching agent is from 0.005 to 0.5%, more preferably from 0.01 to 0.05%, such as for example approximately 0.03% relative to the total weight amount of the thermoplastic polyester.

The 1,4:3,6-dianhydrohexitol unit (A) of the thermoplastic polyester according to the invention can be isosorbide, isomannide, isoidide, or a mixture thereof. Preferably, the 1,4:3,6-dianhydrohexitol unit (A) is isosorbide. Isosorbide, isomannide and isoidide may be obtained, respectively, by dehydration of sorbitol, of mannitol and of iditol. As regards isosorbide, it is sold by the applicant under the brand name Polysorb® P.

The diol unit (B) of the thermoplastic polyester according to the invention can be an alicyclic diol unit, a non-cyclic aliphatic diol unit or a mixture of an alicyclic diol unit and a non-cyclic aliphatic diol unit.

In the case of an alicyclic diol unit, also called an aliphatic and cyclic diol, this is a unit other than 1.4:3,6-dianhydrohexitol. It can thus be a diol chosen from the group comprising 1,4-cyclohexanedimethanol, 1,2-cyclohexanedimethanol, 1,3-cyclohexanedimethanol or a mixture of these diols. Preferably, the alicyclic diol unit is 1,4-cyclohexanedimethanol. The alicyclic diol unit (B) may be in the cis configuration, in the trans configuration, or may be a mixture of diols in the cis and trans configurations.

In the case of a non-cyclic aliphatic diol unit, it may be a linear or branched non-cyclic aliphatic diol, said non-cyclic aliphatic diol possibly also being saturated or unsaturated. A saturated linear non-cyclic aliphatic diol is for example ethylene glycol, 1,3-propanediol, 1,4-butanediol, 1,5-pentanediol, 1,6-hexanediol, 1,8-octanediol and/or 1,10-decanediol. A saturated branched non-cyclic aliphatic diol is for example 2-methyl-1,3-propanediol, 2,2,4-trimethyl-1,3-pentanediol, 2-ethyl-2-butyl-1,3-propanediol, propylene glycol and/or neopentylglycol. An unsaturated aliphatic diol unit is for example cis-2-butene-1,4-diol. Preferably, the non-cyclic aliphatic diol unit is ethylene glycol.

The aromatic dicarboxylic acid unit (C) is chosen from aromatic dicarboxylic acids known to those skilled in the art. The aromatic dicarboxylic acid can be a derivative of naphthalates, terephthalates, furanoates or isophthalates, or mixtures thereof. Advantageously, the aromatic dicarboxylic acid is a terephthalate derivative and, preferably, the aromatic dicarboxylic acid is terephthalic acid.

The molar ratio of 1,4:3,6-dianhydrohexitol units (A)/sum of the 1,4:3,6-dianhydrohexitol units (A) and diol units (B) other than the 1,4:3,6-dianhydrohexitol units (A), i.e. (A)/[(A)+(B)], is at least 0.01 and at most 0.90. Advantageously, this ratio is at least 0.05 and at most 0.65.

The thermoplastic polyester according to the invention has a reduced viscosity in solution, measured using an Ubbelohde capillary viscometer at 25° C. in an equi-mass mixture of phenol and ortho-dichlorobenzene after dissolution of the polymer at 135° C. with stirring, the concentration of thermoplastic polyester introduced being 5 g/l, at least 0.75 dl/g and at most 1.5 dl/g. Preferably, the reduced viscosity in solution is at least 0.90 dl/g and at most 1.3 dl/g.

According to one particular embodiment, in the thermoplastic polyester according to the invention, the 1,4:3,6-dianhydrohexitol unit (A) is isosorbide, the diol unit (B) is cyclohexanedimethanol, and the aromatic dicarboxylic acid unit (C) is terephthalic acid.

According to another particular embodiment, in the thermoplastic polyester according to the invention, the 1,4:3,6-dianhydrohexitol unit (A) is isosorbide, the diol unit (B) is ethylene glycol, and the aromatic dicarboxylic acid unit (C) is terephthalic acid.

The thermoplastic polyester of the invention may for example comprise:
a molar amount of 1,4:3,6-dianhydrohexitol units (A) ranging from 1 to 50%;
a molar amount of diol units (B) other than the 1,4:3,6-dianhydrohexitol units (A) ranging from 5 to 54%;
a molar amount of terephthalic acid units (C) ranging from 45 to 55%,
a weight amount of branching agent relative to the weight of polymer of 0.001 to 1%.

The amounts of the units are expressed relative to the total molar amount of the thermoplastic polyester and can be determined by ¹H NMR or by chromatographic analysis of the mixture of monomers resulting from methanolysis or from complete hydrolysis of the polyester. Preferably, the amounts of different units in the thermoplastic polyester are determined by ¹H NMR.

The thermoplastic polyester according to the invention may be semicrystalline or amorphous. The semicrystalline nature of the polymer depends primarily on the amounts of each of the units in the polymer. Thus, when the polymer according to the invention comprises large amounts of 1,4:3,6-dianhydrohexitol units (A), the polymer is generally amorphous, whereas it is generally semicrystalline in the opposite case.

According to one particular embodiment, the thermoplastic polyester according to the invention is semicrystalline and can thus comprise:
a molar amount of 1,4:3,6-dianhydrohexitol units (A) ranging from 0.5 to 10 mol % and preferably a molar amount of 1 to 7 mol %;
a molar amount of diol units (B) other than the 1,4:3,6-dianhydrohexitol units (A) ranging from 25 to 54.5 mol % and preferably a molar amount ranging from 31 to 54 mol %;
a molar amount of terephthalic acid units (C) ranging from 45 to 55 mol %,
a weight amount of branching agent relative to the weight of polymer of 0.001 to 1%.

Preferably, when the thermoplastic polyester according to the invention is semicrystalline, it has a melting point ranging from 190 to 270° C., for example from 210 to 260° C.

Preferably, when the thermoplastic polyester according to the invention is semicrystalline, it has a glass transition temperature ranging from 75 to 120° C., for example from 80 to 100° C.

The glass transition temperatures and melting points are measured by conventional methods, in particular using differential scanning calorimetry (DSC) with a heating rate of 10° C./min. The experimental protocol is described in detail in the examples section hereinafter.

Advantageously, when the thermoplastic polyester according to the invention is semicrystalline, it has a heat of fusion of greater than 10 J/g, preferably greater than 30 J/g, the measurement of this heat of fusion consisting in subjecting a sample of this thermoplastic polyester to a heat treatment at 170° C. for 10 hours, then in evaluating the heat of fusion by DSC by heating the sample at 10° C./min.

Finally, the thermoplastic polyester according to this embodiment has in particular a lightness L* greater than 40. Advantageously, the lightness L* is greater than 55, preferably greater than 60, most preferentially greater than 65, such as for example greater than 70. The parameter L* may be determined by means of a spectrophotometer, using the CIE Lab model.

According to another embodiment, the thermoplastic polyester according to the invention is amorphous and can thus comprise:
a molar amount of 1,4:3,6-dianhydrohexitol units (A) ranging from 11 to 54 mol % and preferably an amount ranging from 11 to 40 mol %;
a molar amount of alicyclic diol units (B) other than the 1,4:3,6-dianhydrohexitol units (A) ranging from 1 to 44 mol % and preferably a molar amount ranging from 15 to 44 mol %;
a molar amount of terephthalic acid units (C) ranging from 45 to 55 mol %,
a weight amount of branching agent relative to the weight of polymer of 0.001 to 1%.

Preferably, when the thermoplastic polyester according to the invention is amorphous, it has a glass transition temperature ranging from 100 to 210° C., for example from 110 to 160° C.

The thermoplastic polyester according to the invention may have low coloration and especially have a lightness L* greater than 50. Advantageously, the lightness L* is greater than 55, preferably greater than 60, most preferentially greater than 65, for example greater than 70.

The amorphous character of the thermoplastic polyesters used according to the present invention is characterized by the absence of X-ray diffraction lines and also by the absence of an endothermic fusion peak in differential scanning calorimetry analysis.

As previously mentioned, thermoplastic polyester has the advantage of being particularly resistant to the cracking phenomenon but also has improved esterification and polycondensation times. Indeed, the thermoplastic polyester according to the invention has shorter esterification and polycondensation times than the equivalent thermoplastic polyesters based on 1,4:3,6-dianhydrohexitol containing no branching agent.

Another object of the invention therefore relates to a process for producing a thermoplastic polyester according to the invention, said process comprising:
a step of introducing, into a reactor, monomers comprising at least one 1,4:3,6-dianhydrohexitol (A), at least one diol (B) other than the 1,4:3,6-dianhydrohexitols (A) and at least one terephthalic acid (C), the ((A)+(B))/(C) molar ratio ranging from 1.05 to 1.5;
a step of introducing, into the reactor, a branching agent;
a step of introducing, into the reactor, a catalytic system;
a step of polymerizing said monomers in the presence of the branching agent so as to form the thermoplastic polyester, said step consisting of:
   a first stage of oligomerization, during which the reaction medium is stirred under an inert atmosphere at a temperature ranging from 230 to 280° C., advantageously from 250 to 260° C., for example 255° C.;
   a second stage of condensation of the oligomers, during which the oligomers formed are stirred under vacuum, at a temperature ranging from 240 to 300° C. so as to form the thermoplastic polyester, advantageously from 260 to 270° C., for example 265° C.;
a step of recovering the thermoplastic polyester having improved resistance to the cracking phenomenon;
and optionally, a step of solid-state post-condensation of the recovered thermoplastic polyester.

The first stage of oligomerization of the process is carried out in an inert atmosphere, that is to say under an atmosphere of at least one inert gas. This inert gas may in particular be dinitrogen. This first stage may be carried out under a gas stream and it may also be carried out under pressure, for example at an absolute pressure of between 1.05 and 8 bar.

Preferably, the absolute pressure ranges from 2 to 8 bar, most preferably from 2 to 6 bar, for example is 3 bar. Under these preferred pressure conditions, the reaction of all the monomers with one another is promoted by limiting the loss of monomers during this stage.

Prior to the first stage of oligomerization, a step of deoxygenation of the monomers is preferentially carried out. It can be carried out for example once the monomers have been introduced into the reactor, by creating a vacuum then by introducing an inert gas such as nitrogen thereto. This vacuum-inert gas introduction cycle can be repeated several times, for example from 3 to 5 times. Preferably, this vacuum-nitrogen cycle is carried out at a temperature of between 60 and 80° C. so that the reagents, and especially the diols, are totally molten. This deoxygenation step has the advantage of improving the coloration properties of the thermoplastic polyester obtained at the end of the process.

The second stage of condensation of the oligomers is carried out under vacuum. The pressure may decrease continuously during this second stage by using pressure decrease gradients, in steps, or else using a combination of pressure decrease gradients and steps. Preferably, at the end of this second stage, the pressure is less than 10 mbar, most preferentially less than 1 mbar. As previously mentioned, it has been noted, surprisingly, that the presence of the branching agent makes it possible to obtain a shorter time in terms of this polycondensation step.

The first stage of the polymerization step preferably has a duration ranging from 20 minutes to 5 hours. Advantageously, the second stage has a duration ranging from 30 minutes to 6 hours, the beginning of this stage consisting in the moment at which the reactor is placed under vacuum, that is to say at a pressure of less than 1 bar.

The process also comprises a step of introducing a catalytic system into the reactor. This step may take place beforehand or during the polymerization step described above.

The term “catalytic system” is intended to mean a catalyst or a mixture of catalysts, optionally dispersed or attached on an inert support.

The catalyst is used in amounts suitable for obtaining a high-viscosity polymer for the obtaining of the polymer composition.

An esterification catalyst is advantageously used during the oligomerization stage. This esterification catalyst can be chosen from tin derivatives, titanium derivatives, zirconium derivatives, hafnium derivatives, zinc derivatives, manganese derivatives, calcium derivatives and strontium derivatives, organic catalysts such as para-toluenesulfonic acid (PTSA) or methanesulfonic acid (MSA), or a mixture of these catalysts. By way of example of such compounds, mention may be made of those given in application US 2011282020A1 in paragraphs [0026] to [0029], and on page 5 of application WO 2013/062408 A1.

Preferably, a zinc derivative or a manganese, tin or germanium derivative is used during the first stage of transesterification.

By way of example of amounts by weight, use may be made of from 10 to 500 ppm of metal contained in the catalytic system during the oligomerization stage, relative to the amount of monomers introduced.

At the end of transesterification, the catalyst from the first step can be optionally blocked by adding phosphorous acid or phosphoric acid, or else, as in the case of tin(IV), reduced with phosphites such as triphenyl phosphite or tris(nonylphenyl) phosphites or those cited in paragraph [0034] of application US 2011282020A1.

The second stage of condensation of the oligomers may optionally be carried out with the addition of a catalyst. This catalyst is advantageously chosen from tin derivatives, preferentially derivatives of tin, titanium, zirconium, germanium, antimony, bismuth, hafnium, magnesium, cerium, zinc, cobalt, iron, manganese, calcium, strontium, sodium, potassium, aluminum or lithium, or of a mixture of these catalysts. Examples of such compounds may for example be those given in patent EP 1 882 712 B1 in paragraphs [0090] to [0094].

Preferably, the catalyst is a tin, titanium, germanium, aluminum or antimony derivative.

By way of example of amounts by weight, use may be made of from 10 to 500 ppm of metal contained in the catalytic system during the stage of condensation of the oligomers, relative to the amount of monomers introduced.

Most preferentially, a catalytic system is used during the first stage and the second stage of polymerization. Said system advantageously consists of a catalyst based on tin or of a mixture of catalysts based on tin, titanium, antimony, germanium and aluminum.

By way of example, use may be made of an amount by weight of 10 to 500 ppm of metal contained in the catalytic system, relative to the amount of monomers introduced.

According to the preparation process, an antioxidant is advantageously used during the step of polymerization of the monomers. These antioxidants make it possible to reduce the coloration of the thermoplastic polyester obtained. The antioxidants may be primary and/or secondary antioxidants. The primary antioxidant may be a sterically hindered phenol, such as the compounds Hostanox® 0 3, Hostanox® 0 10, Hostanox® 0 16, Hostanox® O3, Ultranox® 210, Ultranox®276, Dovernox® 10, Dovernox® 76, Dovernox® 3114, Irganox® 1010, Irganox® 1076, Irganox 3790, Irganox 1135, Irganox 1019, Irganox 1098, Ethanox 330, ADK Stab AO-80 or a phosphonate such as Irgamod® 195. The secondary antioxidant can be trivalent phosphorus compounds such as Ultranox® 626, Doverphos® S-9228, Hostanox® P-EPQ, ADK Stab PEP-36A, ADK Stab PEP-8, ADK Stab 3010, Alkanox TNPP, Weston 600 or Irgafos 168.

It is also possible to introduce as polymerization additive into the reactor at least one compound that is capable of limiting unwanted etherification reactions, such as sodium acetate, tetramethylammonium hydroxide or tetraethylammonium hydroxide.

Likewise, it is also possible to introduce one or more nucleating agents into the reactor. The nucleating agent can be organic or inorganic and can just as well be added to the reactor before the polymerization step as during the polymerization step. Among the nucleating agents, mention may be made of: talc, calcium carbonate, sodium benzoate, sodium stearate, and also the commercial products Licomont®, Bruggolen® and ADK Stab NA-050.

Finally, the process comprises a step of recovering the thermoplastic polyester at the end of the polymerization step. The thermoplastic polyester thus recovered can then be formed as described above.

According to one particular embodiment, a step of increasing molar mass can be carried out after the step of recovering the thermoplastic polyester.

The step of increasing the molar mass is carried out by post-polymerization and may consist of a step of solid-state polycondensation (SSP) of the semicrystalline thermoplastic polyester or of a step of reactive extrusion of the semicrystalline thermoplastic polyester in the presence of at least one chain extender.

Thus, according to a first variant of the embodiment, when the polyester is semicrystalline, the post-polymerization step is carried out by SSP.

SSP is generally carried out at a temperature between the glass transition temperature and the melting point of the polymer. Thus, in order to carry out the SSP, it is necessary for the polymer to be semicrystalline. Preferably the latter has a heat of fusion of greater than 10 J/g, preferably greater than 20 J/g, the measurement of this heat of fusion consisting in subjecting a sample of this polymer of lower reduced solution viscosity to a heat treatment at 170° C. for 16 hours, then in evaluating the heat of fusion by DSC by heating the sample at 10 K/min.

Advantageously, the SSP step is carried out at a temperature ranging from 190 to 280° C., preferably ranging from 200 to 250° C., this step imperatively having to be carried out at a temperature below the melting point of the semicrystalline thermoplastic polyester. Preferably, this step is carried out after crystallization of the polymer. The SSP step may be carried out in an inert atmosphere, for example under nitrogen or under argon or under vacuum.

According to this first variant, it was surprisingly noticed that the presence of the branching agent made it possible to improve the speed of the SSP, thus considerably reducing the time of this step, which constitutes a not insignificant advantage in terms of cost of implementation of the production process. Likewise, when a crystallization step is carried out during the SSP, the presence of the branching agent also makes it possible to obtain a shorter crystallization time of the thermoplastic polyester.

According to a second variant of the embodiment, the post-polymerization step is carried out by reactive extrusion of the semicrystalline or amorphous thermoplastic polyester in the presence of at least one chain extender.

The chain extender is a compound comprising two functions capable of reacting, in reactive extrusion, with alcohol, carboxylic acid and/or carboxylic acid ester functions of the semicrystalline thermoplastic polyester. The chain extender may, for example, be chosen from compounds comprising two isocyanate, isocyanurate, lactam, lactone, carbonate, epoxy, oxazoline and imide functions, it being possible for said functions to be identical or different. The chain extension of the thermoplastic polyester may be carried out in all of the reactors capable of mixing a very viscous medium with stirring that is sufficiently dispersive to ensure a good interface between the molten material and the gaseous headspace of the reactor. A reactor that is particularly suitable for this treatment step is extrusion.

The reactive extrusion may be carried out in an extruder of any type, especially a single-screw extruder, a co-rotating twin-screw extruder or a counter-rotating twin-screw extruder. However, it is preferred to carry out this reactive extrusion using a co-rotating extruder.

The reactive extrusion step may be carried out by:
introducing the polymer into the extruder so as to melt said polymer;
then introducing the chain extender into the molten polymer;
then reacting the polymer with the chain extender in the extruder;
then recovering the semicrystalline or amorphous thermoplastic polyester obtained in the extrusion step.

During the extrusion, the temperature inside the extruder is adjusted so as to be above the melting point of the polymer. The temperature inside the extruder may range from 150 to 320° C.

The thermoplastic polyester obtained after the step of increasing the molar mass is recovered and then formed as previously described.

Another subject of the invention relates to the use of a thermoplastic polyester as defined above, for the production of a semi-finished or finished plastic item.

The plastic item may be of any type and may be obtained using conventional transformation techniques.

The item according to the invention may for example be a film or a sheet. These films or sheets may be produced by the techniques of calendering, extrusion film cast, extrusion film blowing, followed or not by monoaxial or polyaxial stretching or orientation techniques. These sheets may be thermoformed or injected to be used, for example, for parts such as the viewing windows or covers for machines, the body of various electronic devices (telephones, computers, screens) or else as impact-resistant windows.

In a particularly advantageous manner, the plastic item produced from the thermoplastic polyester according to the invention can be a container for transporting gases, liquids and/or solids. Indeed, by means of the properties of the thermoplastic polyester according to the invention, these plastic items, which are generally subjected to environmental stresses of physical stress or a chemical stress, by means respectively of the pressure or the composition of the contents, have increased resistance to cracking phenomena.

Examples of such containers are for example baby bottles, flasks, bottles, for example sparkling or still water bottles, juice bottles, soda bottles, carboys, alcoholic drink bottles, small bottles, for example small medicine bottles, small bottles for cosmetic products, these small bottles possibly being aerosols, dishes, for example for ready meals, microwave dishes, or else lids. These containers can be of any size and can be produced by techniques known to those skilled in the art, such as, for example, extrusion blow molding, thermoforming or even injection blow molding.

The invention is also described by means of the examples below, which are intended to be purely illustrative and do not in any way limit the scope of the present invention.

### EXAMPLES

The properties of the polymers were analyzed by means of the following methods:

Reduced Viscosity in Solution

Evaluated using an Ubbelohde capillary viscometer at 25° C. in an equi-mass mixture of phenol and ortho-dichlorobenzene after dissolving the polymer at 135° C. with stirring. For these measurements, the polymer concentration introduced is 5 g/l.

Polymer Color

Measured on thermoplastic polyester granules by means of a Konica Minolta CM-2300d spectrophotometer using the CIE Lab model.

Cracking Phenomenon

Measured according to standard ISO 22088-3: 2006 relating to the determination of environmental stress cracking by the bent strip method.

DSC

The sample is first of all heated under a nitrogen atmosphere in an open crucible from 10° C. to 320° C. (10° C.min⁻¹), cooled to 10° C. (10° C.min⁻¹), then heated again to 320° C. under the same conditions as the first step. The glass transition temperatures were taken at the mid-point of the second heating. Any melting points are determined on the endothermic peak (peak onset) in the first heating.

Likewise, the enthalpy of fusion (area under the curve) is determined in the first heating.

The following reagents were used:

Monomers:
Terephthalic acid (purity 99+%) from Accros
Isosorbide (purity >99.5%) Polysorb® P from Roquette Freres
Ethylene glycol (purity >99.8%) from Sigma-Aldrich

Catalysts:
Germanium dioxide (>99.99%) from Sigma Aldrich

Polymerization Additives:
Irganox 1010 from BASF SE: Antioxidant
Hostanox PEPQ from Clariant: Antioxidant
Sodium acetate trihydrate (purity >99.0%): polymerization additive for limiting etherification reactions
Tetraethylammonium hydroxide as a 40% solution in water, from Sigma Aldrich:

polymerization additive limiting etherification reactions

Branching Agent:
Pentaerythritol (99%) from Sigma Aldrich

Nucleating Agents:
Steamic 00SF (Talc) from the company Imerys
NA-05 from the company Adeka.

### Example 1A: Preparation of a Thermoplastic Polyester According to the Invention

A thermoplastic polyester P1 is prepared according to the protocol below. The following are added to a 100 l reactor:
11.44 kg of ethylene glycol,
3.67 kg of isosorbide,
29.00 kg of terephthalic acid,
4.33 g of tetraethylammonium hydroxide solution,
17.60 g of Hostanox PEPQ,
17.60 g of Irganox 1010,
11.59 g of germanium dioxide,
2.65 g of cobalt acetate and
10.59 g of pentaerythritol.

To extract the residual oxygen from the isosorbide crystals, 4 vacuum-nitrogen cycles are performed between 60 and 80° C. The reaction mixture is then heated to 255° C. (4° C./min) under 3 bar of pressure and with constant stirring. The degree of esterification is estimated from the amount of distillate collected.

The pressure is then reduced to 0.7 mbar over the course of 15 minutes and the temperature is brought to 265° C. These vacuum and temperature conditions were maintained for 110 min.

Finally, a polymer rod is cast via the bottom valve of the reactor, cooled in a heat-regulated water bath and chopped in the form of granules.

The poly(ethylene-co-isosorbide) terephthalate resin thus obtained has a reduced viscosity of 0.60 dl/g, a glass transition temperature (Tg) of 90.3° C. and a molar content of isosorbide relative to the diols of 10.3 mol %.

The polymer granules obtained have the following coloring characteristics: L*=69.0, a*=0.1 and b*=−2.3.

The granules thus obtained are subjected to a solid-state post-condensation (SSP) treatment according to the following protocol:

12.5 kg of granules of the preceding polymer are introduced into a 50 l rotary evaporator. The oil bath is then quickly brought to 120° C. and is then gradually heated to 145° C. until optimal crystallization of the granules is obtained after 5.3 hours. This step is carried out under a nitrogen stream at the flow rate of 7.3 l/min.

The round-bottomed flask is then heated at 220° C. under a nitrogen stream of 11.0 l/min, for 47 h.

The polymer thus obtained has a reduced viscosity of 1.23 dl/g, a Tg of 94.0° C. and a molar content of isosorbide relative to the diols of 10.5 mol %. The content of diethylene glycol units relative to the diols is, for its part, 2.0 mol %.

The polymer granules obtained have the following coloring characteristics: L*=87.8, a*=−0.2 and b*=0.6.

### Example 1B: Preparation of a Comparative Thermoplastic Polyester without Branching Agent

In order to serve as a comparison to the thermoplastic polyester P1, a thermoplastic polyester P1′ was prepared and the amounts of the various compounds are reproduced below:
11.44 kg of ethylene glycol,
3.67 kg of isosorbide,
29.00 kg of terephthalic acid,
4.33 g of tetraethylammonium hydroxide solution,
17.60 g of Hostanox PEPQ,
17.60 g of Irganox 1010,
11.59 g of germanium dioxide, and
2.65 g of cobalt acetate.

To extract the residual oxygen from the isosorbide crystals, 4 vacuum-nitrogen cycles are performed between 60 and 80° C. The reaction mixture is then heated to 255° C. (4° C./min) under 3 bar of pressure and with constant stirring. The degree of esterification is estimated from the amount of distillate collected.

The pressure is then reduced to 0.7 mbar over the course of 15 minutes and the temperature is brought to 265° C. These vacuum and temperature conditions were maintained for 110 min.

Finally, a polymer rod is cast via the bottom valve of the reactor, cooled in a heat-regulated water bath and chopped in the form of granules.

The poly(ethylene-co-isosorbide) terephthalate resin thus obtained has a reduced viscosity of 0.57 dl/g, a Tg of 91.0° C. and a molar content of isosorbide relative to the diols of 10.3 mol %. The polymer granules obtained have the following coloring characteristics: L*=69.7, a*=0.0 and b*=−2.1.

The granules thus obtained are subjected to a solid-state post-condensation treatment according to the following protocol:

12.5 kg of granules of the preceding polymer are introduced into a 50 l rotary evaporator. The oil bath is then quickly brought to 120° C. and is then gradually heated to 145° C. until optimal crystallization of the granules is obtained after 6.5 hours. This step is carried out under a nitrogen stream at the flow rate of 7.3 l/min. The round-bottomed flask is then heated at 220° C. under a nitrogen stream of 11.0 l/min, for 60 h.

The thermoplastic polyester Pt thus obtained has a reduced viscosity of 1.18 dl/g, a Tg of 94.0° C. and a molar content of isosorbide relative to the diols of 10.5 mol %. The content of diethylene glycol units relative to the diols is, for its part, 2.0 mol %.

The polymer granules obtained have the following coloring characteristics: L*=86.1, a*=−0.1 and b*=0.1.

### Example 2A: Preparation of a Thermoplastic Polyester According to the Invention

A thermoplastic polyester P2 is prepared according to the protocol below. 1004 g of ethylene glycol, 322 g of isosorbide, 2656 g of terephthalic acid, 0.51 g of tetraethylammonium hydroxide solution, 1.6 g of Hostanox PEPQ, 1.6 g of Irganox 1010, 1.07 g of germanium dioxide, 0.74 g of cobalt acetate, 0.97 g of pentaerythritol and 16.3 g of Talc (Steamic 00SF) previously dispersed in ethylene glycol are added to an 8 l reactor.

To extract the residual oxygen from the isosorbide crystals, 4 vacuum-nitrogen cycles are performed between 60 and 80° C. The reaction mixture is then heated to 255° C. (4° C./min) under 5.7 bar of pressure and with constant stirring. The degree of esterification is estimated from the amount of distillate collected.

The pressure is then reduced to 0.7 mbar over the course of 90 minutes and the temperature is brought to 265° C. These vacuum and temperature conditions were maintained for 125 min.

Finally, a polymer rod is cast via the bottom valve of the reactor, cooled in a heat-regulated water bath and chopped in the form of granules.

The poly(ethylene-co-isosorbide) terephthalate resin thus obtained has a reduced viscosity of 0.61 dl/g, a Tg of 90.6° C. and a molar content of isosorbide relative to the diols of 10.1 mol %. The content of diethylene glycol units relative to the diols is, for its part, 2.2 mol %.

The granules thus obtained are subjected to a solid-state post-condensation treatment according to the following protocol: 2.7 kg of granules of the preceding polymer are introduced into a 50 l rotary evaporator. The oil bath is then quickly brought to 120° C. and is then gradually heated to 145° C. until optimal crystallization of the granules is obtained after 3 hours. This step is carried out under a nitrogen stream at the flow rate of 3.3 l/min. The round-bottomed flask is then heated at 220° C. under a nitrogen stream of 3.3 l/min, for 31 h. The polymer thus obtained has a reduced viscosity of 0.95 dl/g.

### Example 2B: Preparation of a Comparative Thermoplastic Polyester

In order to serve as a comparison to the thermoplastic polyester P2, a thermoplastic polyester PT was prepared. 1004 g of ethylene glycol, 322 g of isosorbide, 2656 g of terephthalic acid, 0.51 g of tetraethylammonium hydroxide solution, 1.6 g of Hostanox PEPQ, 1.6 g of Irganox 1010, 1.07 g of germanium dioxide, 0.74 g of cobalt acetate and 16.3 g of Talc (Steamic 00SF) previously dispersed in ethylene glycol are added to an 8 l reactor.

To extract the residual oxygen from the isosorbide crystals, 4 vacuum-nitrogen cycles are performed between 60 and 80° C. The reaction mixture is then heated to 255° C. (4° C./min) under 5.7 bar of pressure and with constant stirring. The degree of esterification is estimated from the amount of distillate collected.

The pressure is then reduced to 0.7 mbar over the course of 90 minutes and the temperature is brought to 265° C. These vacuum and temperature conditions were maintained for 200 min.

Finally, a polymer rod is cast via the bottom valve of the reactor, cooled in a heat-regulated water bath and chopped in the form of granules.

The poly(ethylene-co-isosorbide) terephthalate resin thus obtained has a reduced viscosity of 0.63 dl/g, a Tg of 89.0° C. and a molar content of isosorbide relative to the diols of 9.8 mol %. The content of diethylene glycol units relative to the diols is, for its part, 2.4 mol %.

The granules thus obtained are subjected to a solid-state post-condensation treatment according to the following protocol: 2.8 kg of granules of the preceding polymer are introduced into a 50 l rotary evaporator. The oil bath is then quickly brought to 120° C. and is then gradually heated to 145° C. until optimal crystallization of the granules is obtained after 4.3 hours. This step is carried out under a nitrogen stream at the flow rate of 3.3 l/min. The round-bottomed flask is then heated at 220° C. under a nitrogen stream of 3.3 l/min, for 40 h. The polymer thus obtained has a reduced viscosity of 0.93 dl/g.

### Example 3A: Preparation of a Thermoplastic Polyester According to the Invention

A thermoplastic polyester P3 was prepared according to the protocol below. 977 g of ethylene glycol, 270 g of isosorbide, 2656 g of terephthalic acid, 1.02 g of tetraethylammonium hydroxide solution, 1.6 g of Hostanox PEPQ, 1.6 g of Irganox 1010, 1.05 g of germanium dioxide, 0.33 g of cobalt acetate, 0.96 g of pentaerythritol and 9.5 g of NA05 are added to an 8 l reactor.

To extract the residual oxygen from the isosorbide crystals, 4 vacuum-nitrogen cycles are performed between 60 and 80° C. The reaction mixture is then heated to 255° C. (4° C./min) under 5.7 bar of pressure and with constant stirring. The degree of esterification is estimated from the amount of distillate collected.

The pressure is then reduced to 0.7 mbar over the course of 90 minutes and the temperature is brought to 265° C. These vacuum and temperature conditions were maintained for 190 min.

Finally, a polymer rod is cast via the bottom valve of the reactor, cooled in a heat-regulated water bath and chopped in the form of granules.

The poly(ethylene-co-isosorbide) terephthalate resin thus obtained has a reduced viscosity of 0.63 dl/g, a Tg of 89.9° C., a molar content of isosorbide relative to the diols of 8.7 mol % and a content of diethylene glycol units of 2.2 mol % relative to the diols.

The granules thus obtained are subjected to a solid-state post-condensation treatment according to the following protocol: 2.7 kg of granules of the preceding polymer are introduced into a 50 l rotary evaporator. The oil bath is then quickly brought to 120° C. and is then gradually heated to 145° C. until optimal crystallization of the granules is obtained after 3.6 hours. This step is carried out under a nitrogen stream at the flow rate of 3.3 l/min. The round-bottomed flask is then heated at 220° C. under a nitrogen stream of 3.3 l/min, for 42 h.

The polymer thus obtained has a reduced viscosity of 1.20 dl/g, a Tg of 92.1° C., a molar content of isosorbide relative to the diols of 8.8 mol % and a content of diethylene glycol units of 2.2 mol % relative to the diols.

### Example 3B: Preparation of a Comparative Thermoplastic Polyester

In order to serve as a comparison to the thermoplastic polyester P3, a thermoplastic polyester P3′ was prepared. 977 g of ethylene glycol, 270 g of isosorbide, 2656 g of terephthalic acid, 1.02 g of tetraethylammonium hydroxide solution, 1.6 g of Hostanox PEPQ, 1.6 g of Irganox 1010, 1.05 g of germanium dioxide and 0.33 g of cobalt acetate are added to an 8 l reactor.

To extract the residual oxygen from the isosorbide crystals, 4 vacuum-nitrogen cycles are performed between 60 and 80° C. The reaction mixture is then heated to 255° C. (4° C./min) under 5.7 bar of pressure and with constant stirring. The degree of esterification is estimated from the amount of distillate collected.

The pressure is then reduced to 0.7 mbar over the course of 90 minutes and the temperature is brought to 265° C. These vacuum and temperature conditions were maintained for 170 min.

Finally, a polymer rod is cast via the bottom valve of the reactor, cooled in a heat-regulated water bath and chopped in the form of granules.

The poly(ethylene-co-isosorbide) terephthalate resin thus obtained has a reduced viscosity of 0.64 dl/g, a Tg of 89.6° C., a molar content of isosorbide relative to the diols of 8.7 mol % and a content of diethylene glycol units of 2.2 mol % relative to the diols.

The granules thus obtained are subjected to a solid-state post-condensation treatment according to the following protocol: 2.4 kg of granules of the preceding polymer are introduced into a 50 l rotary evaporator. The oil bath is then quickly brought to 120° C. and is then gradually heated to 145° C. until optimal crystallization of the granules is obtained after 5 hours. This step is carried out under a nitrogen stream at the flow rate of 3.3 l/min. The round-bottomed flask is then heated at 220° C. under a nitrogen stream of 3.3 l/min, for 40 h.

The polymer thus obtained has a reduced viscosity of 1.09 dl/g and a Tg of 92.0° C. The contents of isosorbide and of diethylene glycol remain unchanged.

### Example 4: Evaluation of the Crack Resistance of the Thermoplastic Polyesters Prepared

In order to compare the resistance to the cracking phenomenon, the various thermoplastic polyesters prepared in the preceding examples are subjected to a cracking test.

The cracking test implemented is based on standard ISO 22088: Determination of environmental stress cracking, part 3: Bent strip method.

Thermoplastic polyesters P1, Pt, P2, PT, P3 and P3′ are dried under vacuum at 150° C. and then injection molded in the form of test specimens 5A. The test specimens are then placed on the test supports.

To induce cracking, two media were tested on the test specimens:
Medium 1: pure citronellol at 38° C.,
Medium 2: water/citronellol emulsion at a 98/2 ratio at 38° C.

For each thermoplastic polyester, the results are confirmed with 3 test specimens. The effect of the media on the test specimens is observed over time and a score of 1 to 5 is assigned according to the following scale:
1: No cracks
2: Appearance of microcracks
3: Some microcracks and cracks
4: Significant cracking phenomenon
5: Very significant cracking phenomenon.

The results are presented in tables 1 to 3 below.

TABLE 1A
Comparison of thermoplastic polyesters P1 and P1′ with medium 2

Water/citronellol

| emulsion (98/2 | Time | | | | | | | | | | |
|---|---|---|---|---|---|---|---|---|---|---|---|
| ratio), 38° C. | 2 h | 15 h | 24 h | 4 days | 7 days | 14 days | 21 days | 28 days | 35 days | 42 days | 49 days |
| P1 | 1 | 1 | 1 | 1 | 1 | 1 | 1 | 1 | 1 | 1 | 1 |
| P1′ | 1 | 1 | 1 | 1 | 2 | 2 | 2 | 2 | 3 | 3 | 3 |

TABLE 1B
Comparison of thermoplastic polyesters P1 and P1′ with medium 1

| Pure | |
|---|---|
| citronellol | Time |

| at 38° C. | 1 h | 24 h | 6 days | 26 days |
|---|---|---|---|---|
| P1 | 1 | 1 | 1 | 1 |
| P1′ | 2 | 2 | 3 | 3 |

In medium 2, the thermoplastic polyester P1 according to the invention shows no cracks, even after 49 days. Conversely, for thermoplastic polyester Pt not containing branching agent, microcracks appear after 7 days and cracks appear after 35 days.

These results are confirmed with the more aggressive medium 1 of pure citronellol, for which the thermoplastic polyester P1 shows no cracks even after 26 days, unlike thermoplastic polyester P1′ for which microcracks appear after 1 hour only, and cracks appear after 6 days.

TABLE 2
Comparison of the thermoplastic polyesters P2 and P2′

Water/citronellol

| emulsion (98/2 | Time | | | | | | | | | | |
|---|---|---|---|---|---|---|---|---|---|---|---|
| ratio), 38° C. | 2 h | 15 h | 24 h | 4 days | 7 days | 14 days | 21 days | 28 days | 35 days | 42 days | 49 days |
| P2 | 1 | 1 | 1 | 1 | 1 | 1 | 1 | 1 | 1 | 1 | 1 |
| P2′ | 1 | 1 | 2 | 2 | 3 | 3 | 3 | 3 | 3 | 4 | 4 |

The results show that the thermoplastic polyester according to the invention P2 shows no cracking phenomenon, even after 49 days in medium 2.

Conversely, in this same medium 2, the thermoplastic polyester PT reveals microcracks after 24 h and cracks after 7 days, and a significant cracking phenomenon is observed starting from 42 days of exposure.

This comparison with medium 2 again demonstrates the effectiveness of the thermoplastic polyesters according to the invention in terms of crack resistance.

TABLE 3A
Comparison of thermoplastic polyesters P3 and P3′ with medium 2

Water/citronellol

| emulsion (98/2 | Time | | | | | | | | |
|---|---|---|---|---|---|---|---|---|---|
| ratio), 38° C. | 2 h | 15 h | 24 h | 4 days | 7 days | 11 days | 18 days | 4 weeks | 5 weeks |
| P3 | 1 | 1 | 1 | 1 | 1 | 1 | 1 | 1 | 1 |
| P3′ | 1 | 1 | 1 | 1 | 1 | 1 | 1 | 2 | 3 |

TABLE 3B
Comparison of thermoplastic polyesters P3 and P3′ with medium 1

Pure

| citronellol, | Time | | | | | | | | |
|---|---|---|---|---|---|---|---|---|---|
| 38° C. | 2 h | 15 h | 24 h | 4 days | 7 days | 11 days | 18 days | 4 weeks | 5 weeks |
| P3 | 1 | 1 | 1 | 1 | 1 | 1 | 1 | 1 | 1 |
| P3′ | 2 | 2 | 3 | 4 | 4 | 4 | 4 | 4 | 4 |

In medium 2, the thermoplastic polyester according to the invention shows no cracks, even after 5 weeks of exposure. Conversely, the thermoplastic polyester P3′ shows microcracks after 4 weeks and cracks after 5 weeks of exposure.

These results are confirmed with medium 1 which is more aggressive with respect to the stresses exerted and for which the thermoplastic polyester P3 according to the invention shows no cracks even after 5 weeks of exposure, whereas for the comparative thermoplastic polyester P3′, microcracks appear after 2 h, cracks appear after 24 h, and a significant cracking phenomenon appears after only 4 days.

The cracking tests carried out in this example thus make it possible to confirm the high resistance of the thermoplastic polyesters according to the invention with respect to cracking phenomena.

### Example 5: Comparison of the Time of the Various Steps of Preparing the Polyesters P2 and PT

The purpose of this example is to demonstrate the effect of the branching agent in the thermoplastic polyester according to the invention on the esterification, polycondensation, crystallization and solid-state post-condensation time.

The various times of the steps of preparing the thermoplastic polyesters P2 and P2′ are shown in table 4 below:

TABLE 4

| | | | | | Solid-state | Solid-state |
|---|---|---|---|---|---|---|
| | Ester- | Polyconden- | Crystal- | | post- | post- |
| | ification | sation | lization | | condensation | condensation |
| | time | time | time | | time | rate (dl/g/h) |
| P2 | 180 min | 90 + 125 min | 3 | h | 31 h | 0.0110 |
| P2′ | 190 min | 90 + 200 min | 4.3 | h | 40 h | 0.0075 |

As demonstrated in the comparative table, the presence of the branching agent allows an improvement in all of the times that were compared. Regarding the solid-state post-condensation time, the improvement in rate results in a significant reduction in the time required to perform this step since 9 h less are observed for the thermoplastic polyester P1.

This example thus demonstrates that the use of the branching agent according to the invention in a process for producing a thermoplastic polyester comprising in particular 1,4:3,6-dianhydrohexitol units provides a not insignificant advantage in terms of time and, consequently, in terms of production cost.

1. A thermoplastic polyester comprising:
at least one 1,4:3,6-dianhydrohexitol unit (A),
at least one diol unit (B), other than the 1,4:3,6-dianhydrohexitol unit (A),
at least one aromatic dicarboxylic acid unit (C),
said polyester being characterized in that it comprises a branching agent and in that it has a reduced viscosity in solution of at least 0.90 dl/g and at most 1.3 dl/g measured using an Ubbelohde capillary viscometer at 25° C. in an equi-mass mixture of phenol and ortho-dichlorobenzene after dissolution of the polymer at 135° C. with stirring, the concentration of polyester introduced being 5 g/l.

2. The thermoplastic polyester as claimed in claim 1, characterized in that the 1,4:3,6-dianhydrohexitol unit (A) is isosorbide, isomannide, isoidide, or a mixture thereof.

3. The thermoplastic polyester as claimed in claim 1, characterized in that the diol unit (B) is an alicyclic diol unit, a non-cyclic aliphatic diol unit or a mixture of an alicyclic diol unit and a non-cyclic aliphatic diol unit.

4. The thermoplastic polyester as claimed in claim 3, characterized in that the alicyclic diol unit is chosen from the group comprising 1,4-cyclohexanedimethanol, 1,2-cyclohexanedimethanol, 1,3-cyclohexanedimethanol or a mixture of these diols, the alicyclic diol unit preferably being 1,4-cyclohexanedimethanol.

5. The thermoplastic polyester as claimed in claim 3, characterized in that the non-cyclic aliphatic diol unit is chosen from the group comprising ethylene glycol, 1,3-propanediol, 1,4-butanediol, 1,5-pentanediol, 1,6-hexanediol, 1,8-octanediol, 2-methyl-1,3-propanediol, 2,2,4-trimethyl-1,3-pentanediol, 2-ethyl-2-butyl-1,3-propanediol, propylene glycol, neopentylglycol, cis-2-butene-1,4-diol, preferably ethylene glycol.

6. The thermoplastic polyester as claimed in claim 1, characterized in that the aromatic dicarboxylic acid unit (C) is chosen from the group comprising derivatives of naphthalates, terephthalates, furanoates and isophthalates, or mixtures thereof.

7. The thermoplastic polyester as claimed in claim 6, characterized in that the aromatic dicarboxylic acid unit (C) is terephthalic acid.

8. The thermoplastic polyester as claimed in claim 1, characterized in that the branching agent is chosen from malic acid, sorbitol, glycerol, pentaerythritol, pyromellitic anhydride, pyromellitic acid, trimellitic anhydride, trimesic acid, citric acid, trimethylolpropane, and mixtures thereof.

9. A process for producing the thermoplastic polyester as claimed in claim 1, said process comprising:
a step of introducing, into a reactor, monomers comprising at least one 1,4:3,6-dianhydrohexitol (A), at least one diol (B) other than the 1,4:3,6-dianhydrohexitols (A) and at least one terephthalic acid (C), the ((A)+(B))/(C) molar ratio ranging from 1.05 to 1.5;
a step of introducing, into the reactor, a branching agent;
a step of introducing, into the reactor, a catalytic system;
a step of polymerizing said monomers in the presence of the branching agent so as to form the thermoplastic polyester, said step consisting of:
a first stage of oligomerization, during which the reaction medium is stirred under an inert atmosphere at a temperature ranging from 230 to 280° C., advantageously from 250 to 260° C.;
a second stage of condensation of the oligomers, during which the oligomers formed are stirred under vacuum, at a temperature ranging from 240 to 300° C. so as to form the thermoplastic polyester, advantageously from 260 to 270° C.;
a step of recovering the thermoplastic polyester having improved resistance to the cracking phenomenon.

10. The production process as claimed in claim 9, characterized in that it comprises a step of increasing molar mass by post-polymerization, said step being carried out by solid-state polycondensation of the thermoplastic polyester.

11. A semi-finished or finished plastic item, comprising the thermoplastic polyester according to claim 1.
